(19) United States
(12) Patent Application Publication
(10) Pub. No.: US 2017/0061298 A1
(43) Pub. Date: Mar. 2, 2017

(54) Analyzing Social Media Posts and Campaigns

(71) Applicant: PicScor, LLC, Fairfield, CT (US)

(72) Inventors: Chris Lynes, New York, NY (US); Tom Balanda, Fairfield, CT (US)

(73) Assignee: PicScor, LLC, Fairfield, CT (US)

(21) Appl. No.: 15/237,551

(22) Filed: Aug. 15, 2016

Related U.S. Application Data
(60) Provisional application No. 62/210,753, filed on Aug. 27, 2015.

(51) Int. Cl. G06N 5/04

(52) U.S. Cl. CPC G06N 5/04

(57) ABSTRACT

Systems and methods for analyzing social media posts and social media campaigns are provided. The system may be a social media post analyzer processor configured to communicate with a plurality of external servers and a plurality of external user devices for the purposes of obtaining data on a plurality of social media posts and interactions with that plurality of posts, and configured to store and compute results based on interactions with those posts. The system can generate analysis and reports based on those interactions and provide users with information to alter and improve social media posts and campaigns by optimizing social media strategy. The present invention solves problems with the currently available social media metrics by providing social media post and campaign analysis to help users reach their intended audience, and offer analysis of trends and correlations.

### FIELD OF THE INVENTION

The presently disclosed subject matter relates to social media analysis, and more specifically, to systems and methods for analyzing a plurality of social media posts or for analyzing a social media campaign to optimize how users can reach an intended audience with a social media strategy, and for processing trends and correlations in audience interactions with social media posts or campaigns.

### BACKGROUND OF THE INVENTION

The term “social media” has been defined in a variety of ways, but a generally accepted definition refers to services that are internet-based applications, interoperable across a range of platforms, and which rely on user-generated content (UGC), for which each user creates a profile specific to that social media platform (e.g., a service or site or app), and which allow users to connect with the profiles of other users and/or groups. While the particular form of a particular social media service may be a blog or microblog, a forum for a topic or community or discussion of news or other items, a social network, a site for reviews of products and/or services, a virtual world, a site for video or file sharing, or a site for gaming, any social media service will generally allow or require users to register accounts and encourage users to share their own content, often referred to as posts, and view the content shared by other users.

Social media presents great opportunities to businesses and individuals seeking to build awareness of a product, service, idea, or person. By creating a campaign, comprising a plurality of posts, a social media user can market goods, or services, or a political campaign or policy idea, or just about anything. There is a technical challenge with this ability to use social media marketing campaigns to deliver content directly to consumers: how to measure the impact that one or more social media posts had. This is a problem related to the use of computers for social media.

With older, more established forms of marketing, such as print or broadcast advertisements, or email marketing or online surveys and advertisements, there are known means to track the reach and impact of the marketing campaign: for instance, tracking responses to print or broadcast advertisements through the use of multiple phone numbers, physical addresses, email addresses, or url extensions passed through in a link, any of which indicate which advertisement or marketing message an individual is responding to.

With social media posts and campaigns, a user of social media running a social media campaign will want assessment and analysis of public interaction on social media platforms with the plurality of social media posts that the user has shared on a plurality of social media platforms. In short, a user of social media will want to measure the impact of a social media post or campaign. Social media campaigns present new opportunities to reach a targeted audience as well as the general public, but without proper analysis of the impact that a plurality of social media posts has had, by measuring the interactions among a desired demographic, a social media user will not be able to assess the effectiveness of their social media campaign.

In the prior art, with current social media platforms and analysis, a social media user can assess interactions with, and other data about, each individual social media post the user has made. The problems with the current approaches to analyzing social media posts is that they do not allow the user to track interactions with a post over a pre-defined time period or at pre-defined intervals, or compare those interactions to expected values, based on factors related to the user, factors related to the posts, and other variables. The prior art also does not allow a user to assess multiple posts as part of a social media campaign. Finally, the prior art does not allow a user to assess a post or a campaign of a plurality of posts with weighting of interactions by groups of users, either to underweight the interactions of a plurality of users (who may overpost, or may be “bots”: computer programs that over-interact, or allow a human user to appear to be online and interacting) or to emphasize the interactions of a different plurality of social media users who the user wants to reach.

### SUMMARY OF THE INVENTION

The present invention meets all these needs, by disclosing systems, and methods, and instructions stored in non-transitory computer-readable media, for analyzing the impact and reach of a plurality of social media posts on at least one target audience segment. The goal of the present invention is to provide a solution for marketing analysis specific to marketing carried out on computer-implemented social media content and public interaction with that social media content, which is a current problem with computer-implemented social media marketing.

In the present invention, a user can define one or more pluralities of target audience segments before posting a first post. The present invention then allows a user to assess a post or a campaign of a plurality of posts with weighting of interactions by groups of users, either to underweight the interactions of one or more pluralities of users, and/or to over-weight (emphasize) the interactions of one or more other pluralities of social media users, which one or more other pluralities of social media users can include but are not limited to the target audience or audiences.

The presently disclosed inventions allow the user to track and analyze interactions with a post over a pre-defined time period and/or at pre-defined intervals, either spaced out or at set times after a social media post is posted by the user.

The inventive systems and methods also allow a user to assess a plurality of posts as part of a social media campaign. Lastly, whether the present invention is being used to assess a single social media post or a campaign, the inventive methods and systems compare the assessed interactions to expected values for interactions, based on factors including but not limited to factors related to the user and factors related to the posts, delivering to the user an assessment of the social media post or social media campaign relative to the expected values for the post or campaign. This can allow the user to assess and potentially alter the content, timing, and/or target audience of future posts or campaigns, which is highly desirable for any user of social media for marketing purposes.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; but the presently disclosed subject matter is not limited to the specific methods and instrumentalities disclosed. In the drawings, like reference characters generally refer to the same components or steps of the device throughout the different figures. In the following detailed description, various embodiments of the present invention are described with reference to the following drawings, in which:

FIG. 1 shows an exemplary method of analyzing the impact of a plurality of social media posts on a plurality of target audience segments, from the perspective of the inventive system.

FIG. 2 shows an exemplary method of analyzing the impact of a plurality of social media posts on a plurality of target audience segments, from the perspective of a user.

FIG. 3 shows an exemplary method of analyzing the impact of a plurality of social media posts on a plurality of target audience segments, from the perspective of a third party.

FIG. 4 shows an exemplary method of assessing the impact of a plurality of social media posts, or of a social media campaign, relative to expected values for the impact of or interactions with the plurality of social media posts or the social media campaign, from the perspective of the inventive system.

FIG. 5 shows an exemplary method of assessing the impact of a plurality of social media posts, or of a social media campaign, relative to expected values for the impact of or interactions with the plurality of social media posts or the social media campaign, from the perspective of a user.

FIG. 6 shows an exemplary method of assessing the impact of a plurality of social media posts, or of a social media campaign, relative to expected values for the impact of or interactions with the plurality of social media posts or the social media campaign, from the perspective of a third party.

FIG. 7 shows an exemplary system configured to carry out the present invention, comprising a plurality of processors, a plurality of memories, a plurality of databases for storage of information related to social media posts and interactions, a plurality of computer-readable media for storing computer-readable instructions, and a plurality of input/out modules for communication with social media platforms and/or user devices.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the methods and systems of the present invention.

The present subject matter discloses systems and methods for analyzing the impact of a plurality of social media posts on a plurality of target audience segments, and for assessing the impact of a plurality of social media posts, or of a social media campaign, relative to expected values for the impact of or interactions with the plurality of social media posts or the social media campaign. A user first registers, e.g. creates an account, with the inventive system. Once the user has done so, the user can define one or more targeted audience segments, and then post one or more posts on one or more social media platforms. The plurality of social media posts may, optionally, be identified by the user as part of a social media campaign. The inventive systems and methods, as described below in greater detail, can then analyze the impact of the plurality of social media posts.

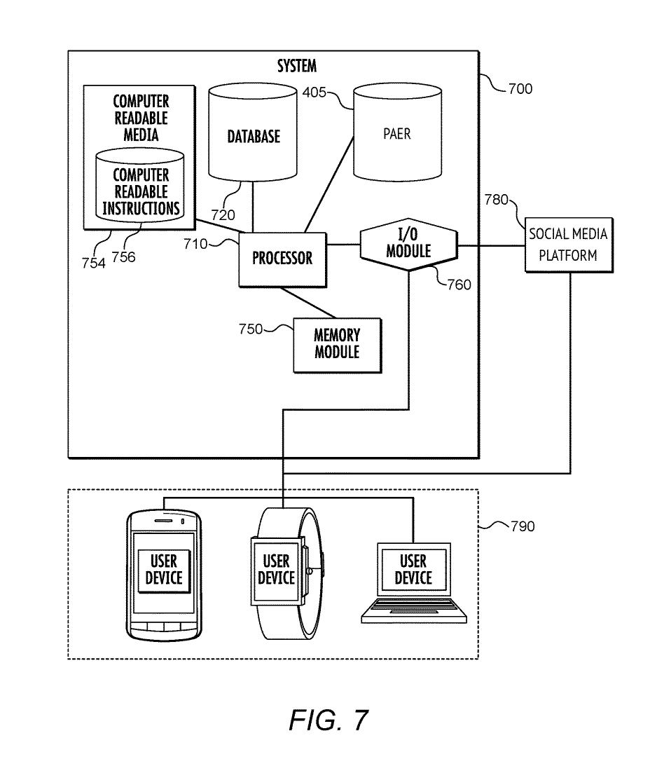

In the following descriptions of the inventive methods of the present disclosure, reference is made to structures and components of the system 700; for further description of such structures and components, refer to the discussion of FIG. 7, below.

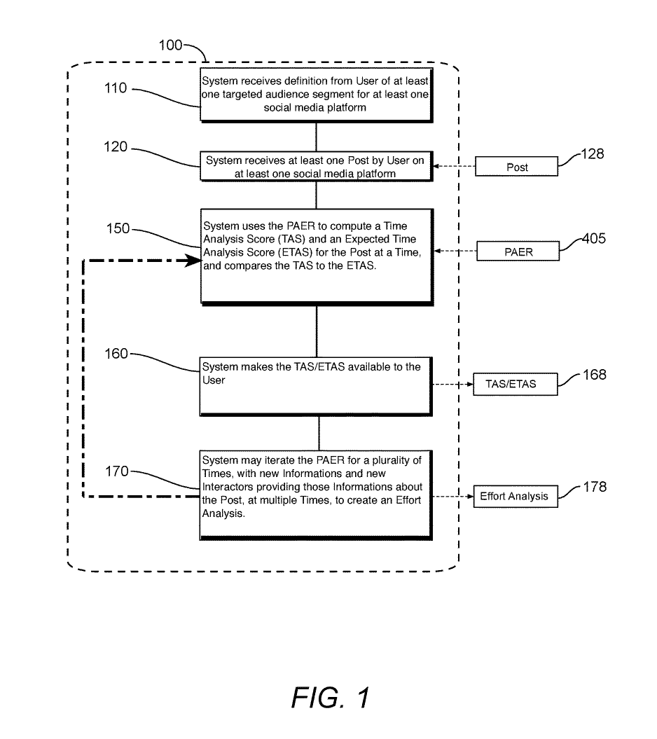

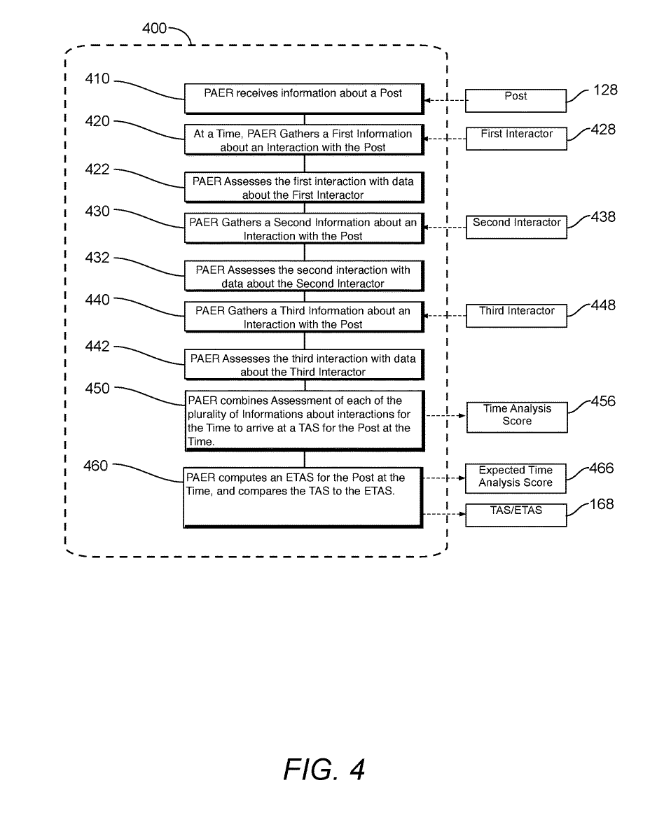

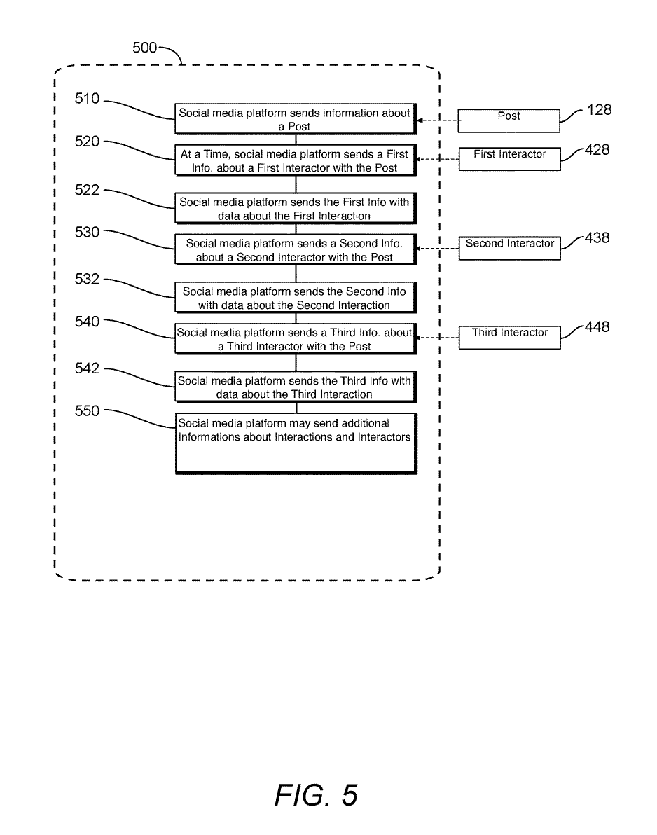

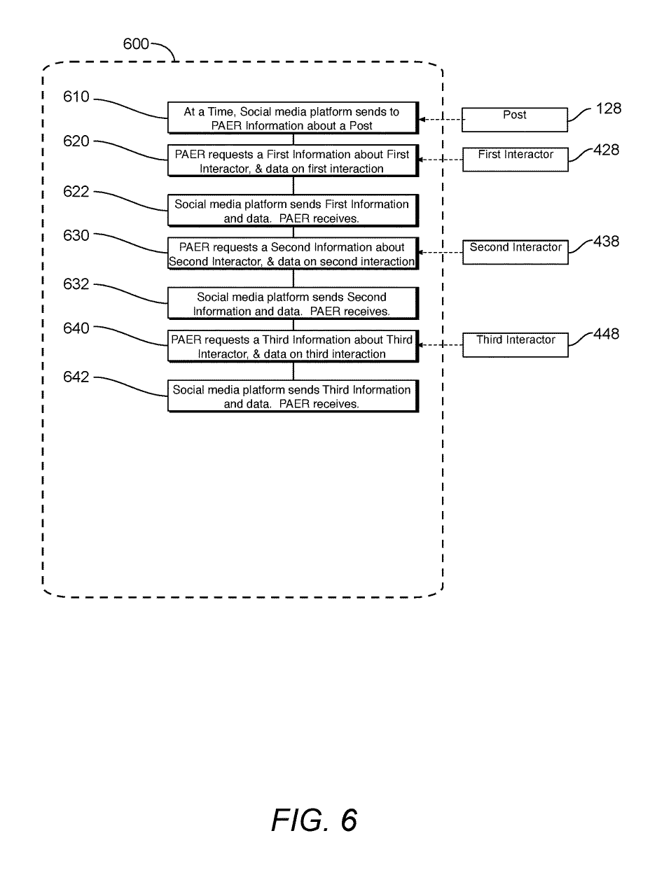

With reference to FIG. 1, a method 100 is presented, from the perspective of the system 700, of the inventive system 700 analyzing the impact of a plurality of social media posts on a plurality of target audience segments, and assessing the impact of a plurality of social media posts, or of a social media campaign, relative to expected values for the impact of or interactions with the plurality of social media posts or the social media campaign. The method 100 is stored in computer-readable media 754. In this embodiment of the present invention, a system 700 receives 110 a definition from a user, using a user device 790, of at least one targeted audience segment for at least one social media platform 780. Later, the system 700 receives 120 at least one social media post 128 by the user on at least one social media platform 780. Thereafter, the system 700 uses 150 a Post Analysis Engine Routine (“PAER”) 405 to compute a time analysis score 456 (“TAS”) and an expected time analysis score 466 (“ETAS”) for the social media post 128 at a particular time, and the system 700 calculates the ratio of the TAS 456 to the ETAS 466, as the TAS/ETAS 168. It has been found advantageous to have the system permit the user to assign different weights, or degrees of importance, to one or more different pluralities of social media users comprising targeted audience segments, non-targeted audience segments, and/or highly influential or highly regarded social media users. For further details on the methods used by the PAER 405, please refer to discussions of FIG. 4, FIG. 5, and FIG. 6, below.

As used throughout this disclosure of the present invention, the phrase “expected values” refers to the ETAS 466 for a social media post 128 at a particular time. The ETAS 466 for a particular time will be based on analysis of historical data on interactions with a plurality of social media posts that is stored by the system 700. The historical data relevant for the TAS 456 for a social media post 128 at a particular time may comprise, but is not limited to, the number of likes, number of comments, and the rate at which each of those or other metrics are acquired or input by users of the social media platform, throughout the life cycle of a given social media post 128. Accordingly, the TAS 456 is based on the actual performance of a social media post 128 at specifically designated intervals, and the TAS/ETAS 168 reflects the TAS 456 relative to the ETAS 466, i.e. the expected performance of a social media post 128 at each of those specifically designated intervals of time, based on social media posts 128, as previously analyzed by the inventive system 700, for the number of likes, number of comments, other relevant or platform-specific types of interactions, and the rate at which those and other relevant metrics have historically been acquired throughout the life cycle of a given social media post 128, as assessed in similar designated intervals of time. It has been found advantageous to have those designated intervals of time be intervals of approximately 5 minutes, starting from the moment the social media post 128 was created and running until the end of the analysis period. It will be obvious to one of skill in the art that other designated time intervals are possible, such as longer or shorter intervals, or intervals of time which vary in length over the course of the analysis period. Accordingly, for every social media post 128, there will be a TAS 456, an ETAS 466, and a TAS/ETAS 168 score for each designated interval of time after a social media post 128 is created, as well as a final TAS 456, a final ETAS 466, and a final TAS/ETAS 168 score for each social media post 128.

After calculating the TAS/ETAS 168, the system 700 may provide 160 the TAS/ETAS 168 to the user. In some embodiments of the present invention, the system iterates the PAER for a plurality of interactions at the particular time, such that the mth information corresponding to and about the mth interactor who had the mth interaction with the social media post 128 or multiple social media posts 128 is used with that mth actor, for some or all total M interactions with the social media post 128. It has been found advantageous to have the system 700 iterate 170 the PAER 405 for a plurality of times, each time using new information about any interactors with the social media post 128 or posts, to create an effort analysis 178, which may be about a plurality of social media posts 128, and/or about a campaign of social media posts 128. The effort analysis 178 contains the assessment of marketing reach and user interaction that is desirable to a user, and is the goal of the present invention.

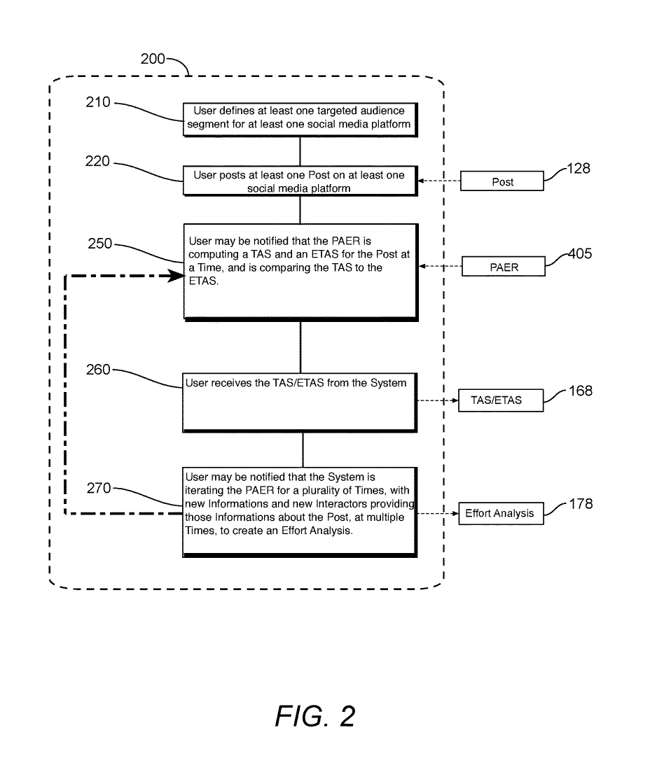

FIG. 2 depicts, from the perspective of an external user device 790, a method 200 of the inventive system 700 analyzing the impact of a plurality of social media posts on a plurality of target audience segments, and assessing the impact of a plurality of social media posts, or of a social media campaign, relative to expected values for the impact of or interactions with the plurality of social media posts or the social media campaign. The method 200 is stored in computer-readable media 754. In this inventive method 200, an external user device 790 is used by the user to define 210 at least one targeted audience segment for at least one social media platform 780. The user device 790 is used by the user to post 220 at least one social media post 128 to at least one social media platform 780. At a later time, the user device 790 is notified 250 that the PAER 405 is computing the TAS, the ETAS, and the TAS/ETAS 168. Thereafter, the user device 790 may receive 260 the TAS/ETAS 168 from the system 700. It has been found advantageous, if the system 700 iterates 170 the PAER 405 to compute the TAS/ETAS 168 for an additional plurality of times for the social media post 128 or a campaign comprising a plurality of social media posts 128, as has been found advantageous, the user device 790 may be notified 270 of that iteration 170 by the system 700, as the system 700 creates an effort analysis 178. It has been found advantageous to have the user use the user device 790 to assign different weights, or degrees of importance, to one or more different pluralities of social media users comprising targeted audience segments, non-targeted audience segments, and/or highly influential or highly regarded social media users, and to have the user device 790 send such weighting to the system 700.

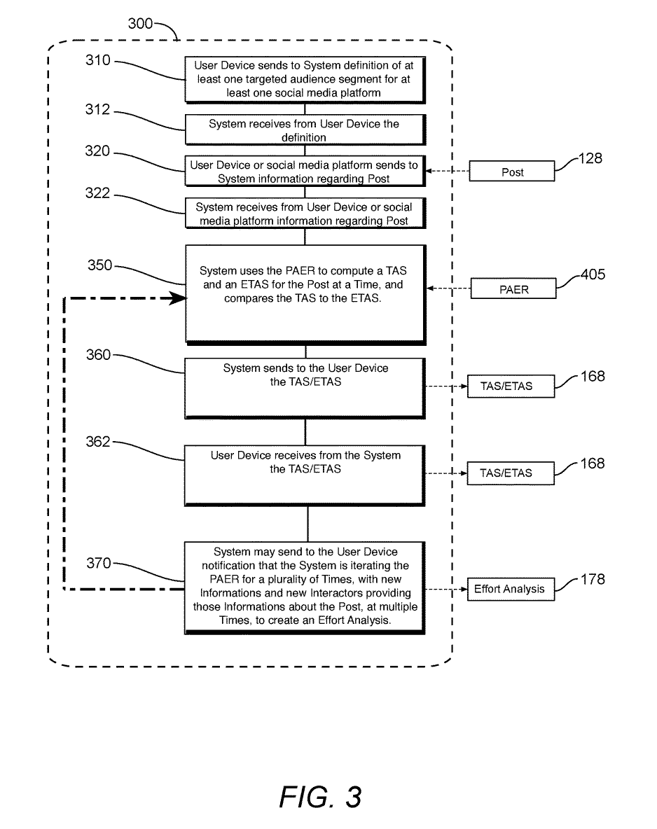

FIG. 3 illustrates, from the perspective of a third party external to the system 700 and a user device 790, a method 300 of the inventive system 700 analyzing the impact of a plurality of social media posts on a plurality of target audience segments, and assessing the impact of a plurality of social media posts, or of a social media campaign, relative to expected values for the impact of or interactions with the plurality of social media posts or the social media campaign. The method 300 is stored in computer-readable media 754. In this inventive method 300, the user device 790 sends 310 to the system 700 a definition, as chosen by a user, of at least one targeted audience segment for at least one social media platform 780. The system receives 312 the definition of the at least one targeted audience segment, utilizing an input/output module 760. The user device 790, or a social media platform 780, sends 320 to the system 700 information regarding at least one social media post 128, and the system 700 thereafter receives 322 from the user device 790 or the social media platform 780 information regarding the social media post 128. The system 700 then uses 350 the PAER 405 to compute a TAS and an ETAS for the social media post 128 at a particular time, and the system 700 calculates the TAS/ETAS 168.

Thereafter, the system 700 may send 360 to the user device 790 the TAS/ETAS 168. The user device 790 receives 362 the TAS/ETAS 168 from the system 700. It has been found advantageous to have the system 700 iterate 170 the PAER 405 for a plurality of times for a given social media post 128 or campaign comprising a plurality of social media posts 128, and if the system 700 so iterates 170, the system 700 may send 370 to the user device 790 notification that the system 700 is so iterating 170 the PAER 405 to create an effort analysis 178.

FIG. 4 depicts a method 400 of the present invention, from the perspective of the system 700, in which the PAER 405 analyzes the impact of a social media post 128 on a plurality of target audience segments at a time Tn by assessing the impact of the social media post 128 relative to expected values for the impact of or interactions with the social media post 128 by members of the target audience segment or segments. The method 400 is stored in computer-readable media 754. In this embodiment of the present invention, the PAER 405 receives 410 information, corresponding to a particular time Tn, about a social media post 128 from a social media platform 780, utilizing an input/output module 760. As discussed in the present disclosure, a time Tn refers to any of the designated intervals of time, numbered 1 through n, up to and including the Nth designated interval of time, where N is the total number of designated intervals of time. The designated intervals of time, as described previously in this disclosure, are the measured lengths of time during which a social media post 128 is assessed.

After receiving 410 input, the PAER 405 gathers 420 a first information about a first interactor 428 who has had a first interaction with the social media post 128. Thereafter, the PAER 405 assesses 422 the first interaction with the first information about the first interactor 428.

It has been found advantageous to have the PAER 405 thereafter gather 430 a second information about a second interactor 438 who has had a second interaction with the social media post 128. Thereafter, the PAER 405 assesses 432 the second interaction with the second information about the second interactor 438. In some embodiments of the present invention, the PAER 405 thereafter gathers 440 a third information about a third interactor 448 who has had a third interaction with the social media post 128. Thereafter, the PAER 405 assesses 442 the third interaction with the third information about the third interactor 448. These steps may optionally be iterated for some or all M interactions with the social media post 128, such that if there are a number M such interactions, the PAER 405 may gather up to M informations about each of the M interactors, and assess some or all of the M interactors with that interactor's respective informations, each time using the mth information about the mth interactor for the mth interaction with the social media post 128 or posts, where the mth interaction, information, and interactor refers to one person and that person's interactions, numbered 1 through M, where M is the total number of such interactions during the relevant nth designated interval of time. It will be obvious to one of skill in the art that the number of interactions M may be greater than the number of interactors, if one of the mth interactors (that is, the up-to M interactors) interacts with the social media post 128 more than one time.

The first information may be information about one or more of the following: comments on the social media post 128; number of likes and/or items that the first interactor 428 has liked historically; time of interaction; length of time and/or time(s) of day and/or days of the week that the first interactor 428 is active or typically active on the social media platform 780; followers of the first interactor 428 at the time of the first interaction; captions or hashtags or other labels or key words used by the first interactor 428, either in the first interaction or historically; and location of the first interactor 428. Along with the foregoing, the PAER 405 may also assess whether the first interactor 428 was identified by the user as a member of a target demographic. Such a target demographic may include but is not limited to “frequent likers”, whose interactions may be underweighted by the PAER 405; “VIP likers”, a group whose interactions may be more valuable or interesting to the user, and whose interactions may therefore be overweighted by the PAER 405; or the group or demographic which the user is trying to reach with a marketing or other message in the social media post 128. Similarly, the information about the second interactor 438, the third interactor 448, or about some or all of the mth interactors with the social media post 128 may comprise any or all of the foregoing.

In this method 400, after the PAER 405 has assessed each of the M interactions desired to be assessed, with information about each of the mth respective interactors, for interactions that had occurred at time Tn, the PAER 405 combines 450 the plurality of assessments for time Tn to arrive at a time analysis score 456 for the social media post 128 at time Tn. Thereafter, the PAER 405 computes 460 an expected time analysis score 466 for the social media post 128 at time Tn, based on factors discussed previously in this disclosure, including but not limited to the number of likes, number of comments, other relevant or platform-specific types of interactions, and the rate at which those and other relevant metrics have historically been acquired throughout the life cycle of a given social media post 128, as assessed in similar designated intervals of time. The PAER 405 then calculates the ratio of TAS 456 to ETAS 466, yielding the TAS/ETAS 168.

The PAER 405 may iterate the method 400 above, as well as the methods described below in the discussions of FIG. 5 and FIG. 6, any number of times. It has been found advantageous to have parameters regarding such iterations by the PAER 405 for assessment of interactions with a social media post 128 set or selected by the user at the time of setting the at least one targeted audience segment. In other embodiments of the invention, the parameters related to the iterations may be changed after the user has posted a social media post 128. The parameters relating to such iterations include but are not limited to the number of times T that the PAER 405 assesses interactions with the social media post 128; the intervals between the times; and the period over which the PAER 405 assesses interactions. It has been found advantageous to have the intervals of time remain at evenly spaced intervals, e.g. the PAER 405 assesses interactions approximate every five minutes. In other embodiments of the invention, the PAER 405 may assess interactions with an increasing period of time between assessments, e.g. at times after the social media post 128 of one minute, two minutes, five minutes, 10 minutes, 20 minutes, 1 hour, 3 hours, 12 hours, 24 hours, and 48 hours. The arrangement of the times of assessment by the PAER 405 may be determined by any other means, including at random. The number of times that a social media post 128 is assessed by the PAER 405 may range from one time to 100 or more times. The duration of time over which a social media post 128 is assessed by the PAER 405 may range from approximately a few minutes, or less time in some implementations of the present invention, to multiple days or even more time. Any of the above parameters for assessment of a social media post 128 by the PAER 405 may also apply to a social media campaign comprising a plurality of social media posts 128.

FIG. 5 depicts a method 500 of the present invention, from the perspective of a social media platform 780, in which the social media platform 780 sends information about interactors (who have interacted with a social media post 128) and their interactions to the PAER 405. The method 500 is stored in computer-readable media 754. In this embodiment of the present invention, a social media platform 780, at a particular time Tn, sends 510 information about a social media post 128 to the PAER 405, utilizing an input/output module 760, and the PAER 405 receives the information. Thereafter, the social media platform 780 sends 520 a first information about a first interactor 428 who has had a first interaction with the social media post 128, and the PAER 405 receives the first information. The social media platform 780 also sends 522 data about the first interaction.

It has been found advantageous to have the social media platform 780 thereafter send 530 a second information about a second interactor 438 who has had a second interaction with the social media post 128, and the PAER 405 receives the second information. The social media platform 780 also sends 532 data about the second interaction. In some embodiments of the present invention, the social media platform 780 sends 540 a third information about a third interactor 448 who has had a third interaction with the social media post 128, and the PAER 405 receives the third information. The social media platform 780 also sends 542 data about the third interaction. These steps may optionally be iterated for some or all interactions with the social media post 128, such that if there are a number M such interactions, the social media platform 780 may gather up to M informations about each of the up-to M interactors, and send to the PAER 405 some or all of the information on the up-to M interactors.

FIG. 6 illustrates, from the perspective of a third party external to the system 700 and a user device 790, a method 600 of the present invention, in which the social media platform 780 and the PAER 405 communicate to send and request information about a social media post 128, and information about interactors who have interacted with the social media post 128, and information about such interactions with the social media post 128. The method 600 is stored in computer-readable media 754. In this embodiment of the present invention, a social media platform 780, at a particular time Tn, sends 610 information about a social media post 128 to the PAER 405, utilizing an input/output module 760, and the PAER 405 receives the information.

Thereafter, the PAER 405 requests 620 a first information about the first interactor 428, and data about the first interaction. The social media platform 780 sends 622 the first information about the first interactor 428, and data about the first interaction, and the PAER 405 receives the first information and the data.

It has been found advantageous to have the PAER 405 request 630 a second information about a second interactor 438, and data about the second interaction. The social media platform 780 sends 632 the second information about the second interactor 438, and data about the second interaction, and the PAER 405 receives the second information and the data. In some embodiments of the present disclosed invention, the PAER 405 requests 640 a third information about a third interactor 448, and data about the third interaction, and the social media platform 780 sends 642 the same, and the PAER 405 receives the third information and the data. These steps may optionally be iterated for some or all interactions with the social media post 128, such that if there are a number M such interactions, the PAER 405 may request a plurality of informations, up to M informations, about a plurality of the M interactors, and data on the plurality of interactions, and the social media platform 780 may send to the PAER 405 a plurality of the information on the up-to M interactors, which the PAER 405 receives.

FIG. 7 illustrates an exemplary system 700 configured to carry out the methods 100, 200, 300, 400, 500, and 600 of the present invention to analyze the impact of a plurality of social media posts on a plurality of target audience segments, and to assess the impact of a plurality of social media posts, or of a social media campaign, relative to expected values for the impact of or interactions with the plurality of social media posts or the social media campaign. The system 700 comprises a plurality of processors 710; a plurality of databases 720; the PAER 405 which may function as an independent module in the system 700; a plurality of memory modules 750; a plurality of computer-readable media 754 for storing a plurality of computer-readable instructions 756 which may include but are not limited to instructions for carrying out any of the presently-disclosed methods 100, 200, 300, 400, 500, and 600; and a plurality of input/output modules 760. In the various inventive methods 100, 200, 300, 400, 500, and 600 described above, the components of the system 700 are communicably connected with each other to communicate with each other and transmit information to carry out the above-described inventive methods 100, 200, 300, 400, 500, and 600.

The system 700 communicates with a plurality of exemplary user devices 790—a few possible user devices 790 are depicted in FIG. 7—in carrying out various of the inventive methods 100, 200, 300, 400, 500, and 600 as previously described, specifically with the processor 710 utilizing an input/output module 760 to communicate with a plurality of user devices 790. The plurality of processors 710 are communicably connected with a plurality of social media platforms 780 to transmit or receive information about social media posts (including but not limited to interactions with social media posts, and information on the interactors), utilizing the plurality of processors 710 and the memory module 750, and computer-readable instructions 756 stored in computer-readable media 754. The system 700 may store information on social media posts, including but not limited to information on interactions with social media posts, interactors interacting with social media posts, and information affiliated with any social media posts, in the plurality of databases 720.

When the system 700 operates the PAER 405, or carries out any of the inventive methods 100, 200, 300, 400, 500, and 600, it utilizes the processor 710, which refers to the plurality of databases 720, and refers to computer-readable instructions 756 stored in computer-readable media 754, to carry out the methods 100, 200, 300, 400, 500, and 600 set forth in the computer-readable instructions 756. The processor 710 utilizes the memory module 750 to process the computer-readable instructions 756.

The various modules and/or functions described above may be implemented by computer-executable instructions, such as program modules, executed by a conventional computer. Generally, program modules include routines, programs, objects, components, data structures, etc. that perform particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The central computing device, also referred to as a processor 710, may comprise or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, the iOS operating system, the Android operating system, the Chrome operating system, an OPENSTEP operating system or another operating system or platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2, Pascal, Prolog, Python, Qt, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Certain embodiments of the present invention were described above. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. A method, stored in computer-readable media, for analyzing the impact of a plurality of social media posts on a plurality of target audience segments, and assessing the impact of a plurality of social media posts, or of a social media campaign, relative to expected values for the impact of or interactions with the plurality of social media posts or the social media campaign, from the perspective of the inventive system, the method comprising:
a system receives a definition from a user of at least one targeted audience segment for at least one social media platform; then
the system receives at least one social media post by the user on at least one social media platform; then
the system calculates the ratio of the time analysis score to the expected time analysis score.

2. The method of claim 1, in which the definition from the user of at least one targeted audience segment for at least one social media platform includes a weighting to each plurality of social media users comprising a targeted audience segment, a non-targeted audience segment, and/or highly influential or highly regarded social media users.

3. The method of claim 1, in which after calculating the ratio of the time analysis score to the expected time analysis score, the system provides the ratio of the time analysis score to the expected time analysis score to the user.

4. The method of claim 1, in which the system iterates the PAER for a plurality of interactions at the particular time, for some or all M interactions with the social media post, for each interaction using the mth information about the mth interactor for the mth interaction with the social media post or posts.

5. The method of claim 1, in which the system iterates the PAER for a plurality of times, each time using new information about the social media post or posts, to create an effort analysis.

6. A method, stored in computer-readable media, for analyzing the impact of a plurality of social media posts on a plurality of target audience segments, and assessing the impact of a plurality of social media posts, or of a social media campaign, relative to expected values for the impact of or interactions with the plurality of social media posts or the social media campaign, from the perspective of an external user device, the method comprising:
an external user device is used by a user to define at least one targeted audience segment for at least one social media platform; then
the user device is used by the user to post at least one social media post to at least one social media platform; and then
the user device is notified by a system that the PAER is computing the TAS, the ETAS, and the TAS/ETAS.

7. The method of claim 6, the method further comprising, after the user device is notified that the PAER is computing the TAS, the ETAS, and the TAS/ETAS, the user device receives the TAS/ETAS from the system.

8. The method of claim 6, the method further comprising the user device being notified by the system that the system has iterated or is iterating the PAER to compute the TAS/ETAS for an additional plurality of times for the social media post or a campaign comprising a plurality of social media posts, as the system creates an effort analysis.

9. The method of claim 6, the method further comprising the user device being used to assign different weights to one or more different pluralities of social media users comprising targeted audience segments, non-targeted audience segments, and/or highly influential or highly regarded social media users, and the user device sending such weighting to the system.

10. A method, stored in computer-readable media, for analyzing the impact of a plurality of social media posts on a plurality of target audience segments, and assessing the impact of a plurality of social media posts, or of a social media campaign, relative to expected values for the impact of or interactions with the plurality of social media posts or the social media campaign, from the perspective of a third party external to a system and a user device, the method comprising:
the user device sends to the system a definition, as chosen by a user, of at least one targeted audience segment for at least one social media platform; then
the system receives the definition of the at least one targeted audience segment, utilizing an input/output module; then
the user device, or a social media platform, sends to the system information regarding at least one social media post; then
the system thereafter receives from the user device or the social media platform information regarding the social media post; then
the system uses the PAER to compute a TAS and an ETAS for the social media post at a particular time; and then
the system calculates the TAS/ETAS.

11. The method of claim 10, the method further comprising the system sending to the user device the TAS/ETAS, and the user device receiving the TAS/ETAS from the system.

12. The method of claim 10, the method further comprising the system 700 iterating the PAER for a plurality of times for a given social media post or campaign comprising a plurality of social media posts.

13. The method of claim 12, the method further comprising the system sending to the user device notification that the system is iterating the PAER to create an effort analysis.

14. A method, stored in computer-readable media, for analyzing the impact of a social media post on a plurality of target audience segments at a time Tn by assessing the impact of the social media post relative to expected values for the impact of or interactions with the social media post by members of a target audience segment or segments, from the perspective of the inventive system, the method comprising:
the PAER receives information, corresponding to a particular time Tn, about a social media post from a social media platform, utilizing an input/output module; then
the PAER gathers a first information about a first interactor who has had a first interaction with the social media post; then
the PAER assesses the first interaction with the first information about the first interactor; then
the PAER combines the plurality of assessments for time Tn to arrive at a time analysis score for the social media post at the time Tn; then
the PAER computes an expected time analysis score for the social media post at time Tn.

15. The method of claim 14, the method further comprising the PAER gathering a plurality of m informations about up-to M interactors, and assessing a plurality of the up-to M interactors with that interactor's respective informations, each time using the mth information about the mth interactor for the mth interaction with the social media post or posts.

16. A method, stored in computer-readable media, for communicating information related to the impact of a social media post on a plurality of target audience segments at a time Tn by assessing the impact of the social media post relative to expected values for the impact of or interactions with the social media post by members of a target audience segment or segments, from the perspective of a social media platform, the method comprising:
a social media platform, at a particular time Tn, sends information about a social media post to a PAER, utilizing an input/output module; then
the PAER receives the information; then
the social media platform sends a first information about a first interactor who has had a first interaction with the social media post, and the PAER receives the first information; and
the social media platform also sends data about the first interaction.

17. The method of claim 16, the method further comprising the social media platform iterating the sending of information about the social media post and the sending of information about the interactor, for some or all interactions with the social media post.

18. A method, stored in computer-readable media, for communicating information related to the impact of a social media post on a plurality of target audience segments at a time Tn by assessing the impact of the social media post relative to expected values for the impact of or interactions with the social media post by members of a target audience segment or segments, from the perspective of a third party external to a PAER, a social media platform, and a user device, the method comprising:
the social media platform, at a particular time Tn, sends information about a social media post to the PAER, utilizing an input/output module; then
the PAER receives the information; then
the PAER requests a first information about a first interactor, and data about the first interaction; then
the social media platform sends the first information about the first interactor 428, and data about the first interaction; and then
the PAER receives the first information and the data.

19. The method of claim 18, the method further comprising the PAER requesting a plurality of informations, up to M informations, about a plurality of the up-to M interactors, and data on the plurality of interactions, and the social media platform sending to the PAER a plurality of the information on the up-to M interactors, which the PAER receives.

20. A system of communicably connected components for analyzing the impact of a plurality of social media posts on at least one target audience segment, the system comprising:
a plurality of processors;
a plurality of memories, which store a plurality of computer-readable instructions;
a plurality of databases for storage of information related to social media posts and interactions;
a plurality of computer-readable media for storing computer-readable instructions; and
a plurality of input/out modules for communication with social media platforms and/or user devices.

21. The system of claim 20, in which the plurality of computer-readable instructions comprise instructions for one or more of:
analyzing the impact of a plurality of social media posts on a plurality of target audience segments; or
assessing the impact of a plurality of social media posts, or of a social media campaign, relative to expected values for the impact of or interactions with the plurality of social media posts or the social media campaign; or
analyzing the impact of a social media post on a plurality of target audience segments at a time Tn by assessing the impact of the social media post relative to expected values for the impact of or interactions with the social media post by members of a target audience segment or segments; or
communicating information related to the impact of a social media post on a plurality of target audience segments at a time Tn by assessing the impact of the social media post relative to expected values for the impact of or interactions with the social media post by members of a target audience segment or segments; or
communicating information related to the impact of a social media post on a plurality of target audience segments at a time Tn by assessing the impact of the social media post relative to expected values for the impact of or interactions with the social media post by members of a target audience segment or segments.

22. Computer-readable instructions, stored in computer-readable media, for analyzing the impact of a plurality of social media posts on a plurality of target audience segments, and assessing the impact of a plurality of social media posts, or of a social media campaign, relative to expected values for the impact of or interactions with the plurality of social media posts or the social media campaign.
